(19) United States
(12) Patent Application Publication
(10) Pub. No.: US 2021/0017312 A1
(43) Pub. Date: Jan. 21, 2021

(54) MULTILAYER ARTICLE WITH HEAT-SEALABLE BARRIER LAYER

(71) Applicant: KURARAY CO., LTD., Kurashiki-shi (JP)

(72) Inventor: Masakazu NAKAYA, Okayama (JP)

(73) Assignee: KURARAY CO., LTD., Kurashiki-shi (JP)

(21) Appl. No.: 16/931,606

(22) Filed: Jul. 17, 2020

Related U.S. Application Data
(60) Provisional application No. 62/875,846, filed on Jul. 18, 2019.

(51) Int. Cl. C08F 216/06; B32B 7/12; B32B 27/36; B32B 27/30; B32B 27/08

(52) U.S. Cl. CPC C08F 216/06; B32B 7/12; B32B 27/36; B32B 27/306; B32B 2307/7248; B32B 2439/70; B32B 2439/80; B32B 2307/31; B32B 2307/7244; B32B 27/08

(57) ABSTRACT

A multilayer article is provided which is suitable for use in food packaging and pharmaceutical packaging industry, wherein the multilayer article having at least one layer of a heat sealable barrier polymer composition (barrier sealant layer), wherein the heat sealable barrier polymer composition comprises a modified ethylene-vinyl alcohol copolymer and the layer of the heat sealable barrier polymer composition is the innermost layer of the multilayer article.

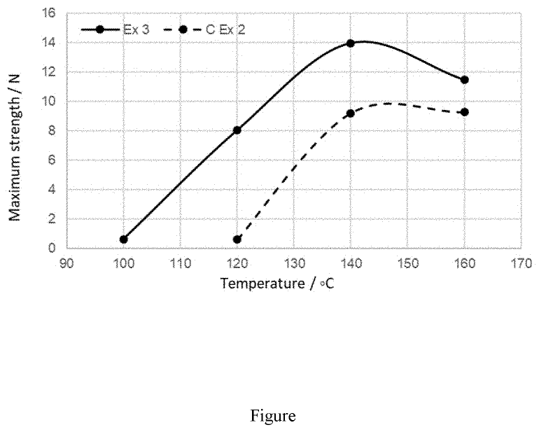

### CROSS REFERENCE TO RELATED APPLICATIONS

This application claims priority under 35 U.S.C. § 119 from U.S. Provisional Application Ser. No. 62/875,846 (filed 18 Jul. 2019), the disclosure of which is incorporated by reference herein for all purposes as if fully set forth.

### FIELD OF THE INVENTION

The present invention relates to a multilayer article having at least one layer of a heat-sealable barrier polymer composition (barrier sealant layer), wherein (i) the heat-sealable barrier polymer composition comprises a modified ethylene-vinyl alcohol copolymer of the formula (I) as shown below with an ethylene content from about 18 to about 55 mol %; (ii) the melt temperature of the heat sealable barrier polymer composition (A) is less than about 160° C.; (iii) a layer of the heat-sealable barrier polymer composition is the innermost layer of the multilayer article. The multilayer article is particularly suitable for use in food and pharmaceutical packaging end uses.

### BACKGROUND OF THE INVENTION

Ethylene-vinyl alcohol copolymers (“EVOH”) are excellent in transparency, melt processability, gas barrier properties, aroma barrier properties, anti-scalping properties and oil resistance. As a result, EVOH is widely used for food, pharmaceutical and the like packaging applications. In many cases, the packages have a multilayer structure to achieve various requirements such as mechanical strength, heat sealability and barrier properties. EVOH is often used as an interior (middle) layer as a barrier layer in the multilayer structure, while polyolefins like polyethylene (PE) and polypropylene (PP) are often used for the exterior (innermost and outermost) layers as a heat sealant layer. Because PE and PP can be heat-sealed well at low temperature due to their relatively low melting temperature, it allows to high-speed sealing and less damage to the packaging during heat seal.

One disadvantage to a sealant layer made from polyolefin is that it can adsorb aroma or ingredients from contents in the packaging. Some sensitive products such as fruit juices, medicines, cosmetics and toiletry products require aroma barrier properties and anti-scalping properties in the sealant layer. EVOH, therefore, would seem to be desirable for use as the innermost layer of such a packaging as the sealant layer.

As described above, low-melting temperature is one of the requirements for sealant materials. Typical melting temperature of conventional EVOH is around 160-195° C., depending on ratio of ethylene unit and vinyl alcohol unit. EVOH having high ethylene content has a sufficiently low melting temperature and can be heat sealed; however, EVOH with high ethylene content may not show enough oxygen barrier properties, aroma barrier properties and anti-scalping properties because of less vinyl alcohol unit. Even if these barrier requirements for contents is not high, it may not achieve other requirements for heal sealant such as enough hot tack properties.

Then, various studies has been done to achieve requirements for the sealant layer.

JP1991-112654A describes multilayer containers using two kinds of EVOH for the innermost layer as a sealant layer. JP2002-338767A describes a heat sealing material which uses both EVOH and polyamide resin. The barrier properties of the described sealant materials, however, is not at a sufficient level as required for some packaging applications.

The present invention overcomes this shortcoming by providing a multilayer article having both excellent barrier properties and heat seal properties, such as heat seal strength and hot tack properties.

### SUMMARY OF THE INVENTION

In view of the above background, the objective of the present invention is to provide a multilayer article having both excellent barrier properties and heat seal properties.

The present invention addresses the above-described problem by providing a multilayer article comprising at least one layer of a heat-sealable barrier polymer composition (A) wherein:

(i) the heat-sealable barrier polymer composition (A) comprises a modified ethylene-vinyl alcohol copolymer the formula (I) as a barrier polymer:

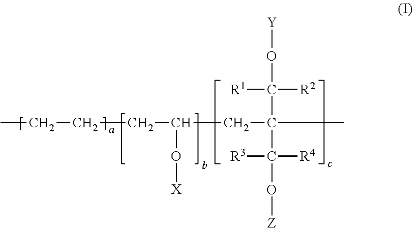

wherein
each of R1, R2, R3, and R4 is independently a hydrogen atom or an alkyl group having a carbon number of from 1 to 10, wherein the alkyl group may optionally include a hydroxyl group, an alkoxy group, or a halogen atom;
each of X, Y, and Z is independently a hydrogen atom, a formyl group, or an alkanoyl group having a carbon number of from 2 to 10.

18≤a≤55;

0.01≤c≤20;

[100−(a+c)]×0.9≤b≤[100−(a+c)]

DS=[(Total Number of Moles of Hydrogen Atoms in X,Y, and Z)/(Total Number of Moles of X,Y, and Z)]×100>90 (4)

(ii) the melt temperature of the heat-sealable barrier polymer composition (A) is less than about 160° C. (measured as set forth in the Examples); and

(iii) a layer of a heat-sealable barrier polymer composition (A) is the innermost layer of the multilayer article.

In one embodiment, each of R1, R2, R3 and R4 is a hydrogen atom.

In one embodiment, each of X, Y, and Z is independently a hydrogen atom or an acetyl group.

In one embodiment, a monolayer film prepared from the heat-sealable barrier polymer composition (A) exhibits an oxygen permeability that is less than about 3.2 cc·20 micron/m2·day·atm (measured as set forth in the Examples).

In another embodiment, the content of the modified group based on the total monomer units is from about 0.05 to about 20 mol % (0.05≤c≤20).

In another embodiment, a flexible packaging is made from the multilayer article.

In another embodiment, a packaged product is provided wherein the product is enclosed in packaging made from the multilayer article as generally described above and more fully described below.

According to the aspects of the present invention, the multilayer article and the flexible packaging shows excellent gas barrier properties, anti-scalping properties and heat-seal properties. It is particularly suitable for use in food and pharmaceutical packaging.

These and other embodiments, features and advantages of the present invention will be more readily understood by those of ordinary skill in the art from a reading of the following detailed description.

### BRIEF DESCRIPTION OF THE DRAWING

FIGURE is a graph showing results from hot tack evaluation as set forth in the Examples.

### DETAILED DESCRIPTION

The present invention relates to a multilayer article having at least one layer of a barrier polymer comprising the modified ethylene-vinyl alcohol copolymer described herein. Further details are provided below.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

As used herein, the term “innermost” layer means the layer of the multilayer article that is intended to be on the product side of the end-use packaging, for example, in contact with the product. Conversely, the “outermost” layer means the layer of the multilayer article that is intended to be opposite the product side of the end-use packaging, for example, in contact with the exterior environment.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Heat-Sealable Barrier Polymer Composition (A)

Multilayer articles in accordance with the present invention have at least one layer of heat-sealable barrier polymer composition comprising a modified EVOH resin. Further details are provided below. Other materials may also be used as long as not inhibiting the effects of the present invention.

### Modified EVOH Resin (a)

In the modified ethylene-vinyl alcohol copolymer used in the present invention, the copolymer is represented by a following formula (I), contents (mol %) of a, b, and c based on the total monomer units satisfy (1) through (3), and a degree of saponification (DS) defined by (4) is not less than 90 mol %. By the presence of the modifier group as described herein, melt temperature of the copolymer is significantly decreased without significant deterioration of barrier properties (as compared to unmodified EVOH with comparable ethylene content).

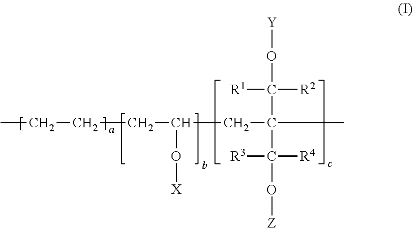

This modified EVOH has, in addition to ethylene units and vinyl alcohol units, monomer units having a 1,3-diol structure in a main chain of the copolymer, which tends to disrupt crystallinity so that melting point decreases compared with EVOH not containing the monomer units. Further, with this modified EVOH, since the 1,3-diol structure has strong hydrogen bonding strength, it is possible to keep excellent barrier properties despite any decrease in crystallinity. Further, as described later, it is possible to produce this modified EVOH at low cost.

In the formula (I), each of R1, R2, R3, and R4 independently denotes a hydrogen atom or an alkyl group having a carbon number of from 1 to 10. R1, R2, R3, and R4 may be same groups and may also be different. The structure of the alkyl group is not particularly limited and may have a branched structure and a cyclic structure in part. In addition, the alkyl group may include a hydroxyl group, an alkoxy group, or a halogen atom. R1, R2, R3, and R4 are preferably individually a hydrogen atom or an alkyl group having a carbon number of from 1 to 5, and more preferably a hydrogen atom. A preferred example of the alkyl group may include a linear or branched alkyl group, such as a methyl group, an ethyl group, an n-propyl group, an isopropyl group, an n-butyl group, an isobutyl group, a tert-butyl group, and a pentyl group.

In the formula (I), each of X, Y, and Z independently denotes a hydrogen atom, a formyl group, or an alkanoyl group having a carbon number of from 2 to 10. The formula (I) has a hydroxyl group in a case that X, Y, or Z is a hydrogen atom, and the formula (I) has an ester group in a case that X, Y, or Z is a formyl group or an alkanoyl group. The alkanoyl group is preferably an alkanoyl group having a carbon number of from 2 to 5 and preferably exemplified by an acetyl group, a propanoyl group, a butanoyl group, and the like. Among them, an acetyl group is particularly preferred. It is preferred that all of X, Y, and Z are a hydrogen atom or a mixture containing a hydrogen atom.

Monomer units containing X are usually obtained by saponifying a vinyl ester. Accordingly, it is preferred that X is a mixture of a hydrogen atom with a formyl group or an alkanoyl group having a carbon number of from 2 to 10. Considering availability of the monomer (vinyl acetate) and production costs, it is particularly preferred that X is a mixture of a hydrogen atom with an acetyl group.

Meanwhile, it is possible to produce monomer units containing Y and Z by copolymerizing unsaturated monomer units having a 1,3-diester structure and then saponifying it. Alternatively, it is also possible to produce them by directly copolymerizing unsaturated monomer units having a 1,3-diol structure. Accordingly, both Y and Z may be a hydrogen atom only, and may also be a mixture of a hydrogen atom with a formyl group or an alkanoyl group having a carbon number of from 2 to 10, more preferably a mixture of a hydrogen atom with an acetyl group.

In the modified EVOH used in the present invention, contents (mol %) of a, b, and c based on the total monomer units satisfy following formulae (1) through (3).

18≤a≤55 (1)

0.01≤c≤20 (2)

[100−(a+c)]×0.9≤b≤[100−(a+c)] (3)

The character “a” denotes a content (mol %) of ethylene units based on the total monomer units. The modified EVOH resin (a) desirably has, as a lower limit of ethylene unit content (a proportion of the number of ethylene units to the total number of monomer units in the modified EVOH resin (a)), an ethylene unit content of about 18 mol % or greater, or about 20 mol % or greater, or about 22 mol % or greater. On the other hand, the modified EVOH resin (a) desirably has, as an upper limit of ethylene unit content, an ethylene unit content of about 55 mol % or less, or about 52 mol % or less, or about 50 mol % or less. The modified EVOH resin (a) having an ethylene unit content of no less than the lower limit and no greater than upper limit gives an excellent oxygen barrier and gives excellent melt processability.

The character “c” content (mol %) of monomer units containing Y and Z shown at the right edge of the formula (I) based on the total monomer units, which is from about 0.01 to about 20 mol %. When “c” is less than about 0.01 mol %, decrease of melting point of the modified EVOH become insufficient. Further, “c” is preferably not less than about 0.05 mol %, or not less than about 0.1 mol %, or not less than about 0.5 mol %. In contrast, when “c” is more than about 20 mol %, crystallinity extremely decreases and thus a barrier property of the modified EVOH decreases. “c” is desirably not more than about 10 mol %, or not more than about 5 mol %. In order to have a particularly excellent barrier property, “c” is desirably not more than about 0.5 mol %, or not more than about 0.3 mol %.

The character “b” denotes a content (mol %) of vinyl alcohol units and vinyl ester units based on the total monomer units. This satisfies the following formula (3).

[100−(a+c)]×0.9≤b≤[100−(a+c)] (3)

That is, in the modified EVOH used in the present invention, not less than about 90% of the monomer units other than the ethylene units and than the monomer units containing Y and Z shown at the right edge of the formula (I) is vinyl alcohol units or vinyl ester units. In a case that the formula (3) is not satisfied, the gas barrier property becomes insufficient. The following formula (3′) is satisfied preferably and the following formula (3″) is satisfied more preferably.

[100−(a+c)]×0.95≤b≤[100−(a+c)] (3′)

[100−(a+c)]×0.98≤b≤[100−(a+c)] (3″)

The modified EVOH of the present invention has a degree of saponification (DS) defined by the following formula (4), which is not less than about 90 mol %:

DS=[(Total Number of Moles of Hydrogen Atoms in X,Y, and Z)/(Total Number of Moles of X,Y, and Z)]×100 (4)

Here, the “total number of moles of hydrogen atoms in X, Y, and Z” shows a number of moles of the hydroxyl group, and the “total number of moles of X, Y, and Z” shows a total number of moles of the hydroxyl group and the ester group. When the degree of saponification (DS) becomes less than 90 about mol %, a sufficient barrier performance is not obtained and moreover thermal stability of the modified EVOH becomes insufficient and gels are easily generated during melt molding.

The degree of saponification (DS) is desirably not less than 95 about mol %, or not less than about 98 mol %, or not less than about 99 mol %. In order to have a barrier property and thermal stability that are particularly excellent, the degree of saponification (DS) is desirably not less than about 99 mol %, or not less than about 99.5 mol %, or not less than about 99.8 mol %.

It is possible to obtain the degree of saponification (DS) by generally known nuclear magnetic resonance (NMR) techniques. It is also possible to obtain the contents of the monomer units represented by a, b, and c above by generally known NMR techniques. In addition, the modified EVOH of the present invention is usually a random copolymer. It is possible to confirm this from NMR and results of melting point measurements.

The modified EVOH resin (a) typically has, as a lower limit of a melt flow rate (a measured value at a temperature of 190° C. and a load of 2160 g in accordance with JIS K7210) of about 0.1 g/10 min or more, or about 0.5 g/10 min or more, or about 1 g/10 min or more.

The modified EVOH resin (a) may be a blend of multiple modified EVOH or EVOH as long as it has required properties. In this case, content of each monomer unit, degree of saponification and melt flow rate of the modified EVOH resin (a) is average number calculated by blend ratio.

The oxygen transmission rate of the modified EVOH used in the present invention at 20° C. and 65% RH is less than about 3.2 cc·20 μm/m²·day·atm (measured as set forth in the Examples). The oxygen transmission rate is desirably not more than about 2.5 cc·20 μm/m²·day·atm, or not more than about 2.0 cc·20 μm/m²·day·atm.

### Other Components in Heat-Sealable Barrier Polymer Composition (A)

It is possible to make the heat-sealable barrier polymer composition (A) by blending another component. For example, it is possible to make the heat-sealable barrier polymer composition (A) that has thermoplastic resins other than the modified EVOH resin (a) or EVOH, plasticizers, lubricants, stabilizers, surfactants, colorants, ultraviolet absorbers, antistatic agents, desiccants, crosslinkers, metal salts, fillers, reinforcing agents such as various fibers, and the like blended therein. The heat sealable barrier polymer composition (A) should contain not more than about 30 wt % of the another component, or not more than about 20 wt % of the another component, or not more than 10 wt % of the another component, or not more than 5 wt % of the another component, based on the total weight of the heat-sealable barrier polymer composition (A).

Among all, it is preferred that the heat-sealable barrier polymer composition (A) contains an alkali metal salt. Although the cationic species of the alkali metal salt is not particularly limited, it is preferably sodium salt or and potassium salt. The anionic species of the alkali metal salt is also not particularly limited. It is possible to add as salt of carboxylic acid, salt of carbonic acid, salt of hydrogencarbonic acid, salt of phosphoric acid, salt of hydrogenphosphoric acid, salt of boric acid, hydroxide, and the like. It is preferred that an alkali metal salt content in the heat sealable barrier polymer composition (A) is from about 10 to about 500 ppm in terms of alkali metal element. The interlayer adhesion may be insufficient in a case that the alkali metal salt content is less than about 10 ppm, and it is more preferably not less than about 50 ppm. In contrast, the melt stability may be insufficient in a case that the alkali metal salt content is more than about 500 ppm, and it is more preferably not more than about 300 ppm.

It is also preferred that the heat-sealable barrier polymer composition (A) contains a phosphoric acid compound. By making a resin composition containing a phosphoric acid compound in such a manner, it is possible to prevent coloration during melt molding. The phosphoric acid compound used for the present invention is not particularly limited, and it is possible to use various acids, such as phosphoric acid and phosphorous acid, and salts thereof. Although the phosphate may be contained in any form of primary phosphate, secondary phosphate, and tertiary phosphate, primary phosphate is preferred. Although the cationic species is also not particularly limited, alkali metal salt is preferred. Among them, sodium dihydrogen phosphate and potassium dihydrogen phosphate are preferred. It is preferred that the phosphoric acid compound content in the heat-sealable barrier polymer composition (A) is from about 5 to about 200 ppm in terms of phosphate radicals. The coloration resistance during melt molding may be insufficient in a case that the phosphoric acid compound content is less than about 5 ppm. In contrast, the melt stability may be insufficient in a case that the phosphoric acid compound content is more than about 200 ppm, and it is more preferably not more than about 160 ppm.

The heat-sealable barrier polymer composition (A) may contain a boron compound. By making a heat-sealable barrier polymer composition (A) containing a boron compound in such a manner, it is possible to suppress torque variation during melting by heating. The boron compound used for the present invention is not particularly limited and may include boric acids, borates, salts of boric acids, boron hydrides, and the like. Specifically, the boric acids may include orthoboric acid, metaboric acid, tetraboric acid, and the like; the borates may include triethyl borate, trimethyl borate, and the like; the salts of boric acids may include alkali metal salts, alkaline earth metal salts of various boric acids mentioned above, borax, and the like. Among these compounds, orthoboric acid (hereinafter, may be described simply as boric acid) is preferred. It is preferred that the boron compound content is preferably from about 20 to not more than about 2000 ppm in terms of boron element. The suppression of torque variation during melting by heating may become insufficient in a case that the boron compound content is less than about 20 ppm, and it is more preferably not less than about 50 ppm. In contrast, in a case that the boron compound content is more than about 2000 ppm, gelation easily occurs and the moldability may deteriorate, and it is more preferably not more than about 1000 ppm.

Among all, the heat-sealable barrier polymer composition (A) may contain thermoplastic resins other than the modified EVOH resin (a) as long as not inhibiting the effects of the present invention. The thermoplastic resin other than the modified EVOH resin (a) used for the heat sealable barrier polymer composition (A) may include polyethylenes, such as linear low density polyethylene, low density polyethylene, very low density polyethylene, medium density polyethylene, and high density polyethylene; homo- or co-polymers of olefin, such as ethylene-vinyl acetate copolymers, ionomers, ethylene-propylene (block or random) copolymers, ethylene-(meth) acrylic acid copolymers, ethylene-(meth)acrylic ester copolymers, polypropylene, propylene-α-olefin copolymers, polybutene, and polypentene, or polyolefins, such as those graft modified with unsaturated carboxylic acid or esters thereof; polyester; polyamide (including copolyamide); polyvinyl chloride; polyvinylidene chloride; acrylic resins; polystyrene; polyvinyl ester; polyester elastomers; polyurethane elastomers; chlorinated polystyrene; chlorinated polypropylene; aromatic polyketone or aliphatic polyketone, and polyalcohol obtained by reducing them; polyacetal; polycarbonate; and the like.

In addition, as long as not inhibiting the effects of the present invention, in order to improve melt stability and the like, heat-sealable barrier polymer composition (A) may contain from about 0.001 to about 1 wt % of one or more kinds of hydrotalcite compound, hindered phenol-based and hindered amine-based heat stabilizers, metal salt of higher fatty carboxylic acid (for example, calcium stearate, magnesium stearate, and the like). Specific examples of such other components may include the following.

Antioxidant: 2,5-di-t-butylhydroquinone, 2,6-di-t-butyl-p-cresol, 4,4′-thiobis-(6-t-butylphenol), 2,2′-methylene-bis-(4-methyl-6-t-butylphenol), octadecyl-3-(3′,5′-di-t-butyl-4′-hydroxyphenyl)propionate, 4,4′-thiobis-(6-t-butylphenol), and the like.

Ultraviolet absorber: ethylene-2-cyano-3,3′-diphenyl acrylate, 2-(2′-hydroxy-5′-methylphenyl)benzotriazole, 2-(2′-hydroxy-3′-t-butyl-5′-methylphenyl) 5-chlorobenzotriazole, 2-hydroxy-4-methoxybenzophenone, 2,2′-dihydroxy-4-methoxybenzophenone, and the like.

Plasticizer: dimethyl phthalate, diethyl phthalate, dioctyl phthalate, wax, liquid paraffin, phosphates, and the like.

Antistatic agent: pentaerythritol monostearate, sorbitan monopalmitate, sulfated polyolenns, polyethylene oxide, Carbowax, and the like.

Lubricant: ethylene bisstearoamide, butyl stearate, and the like.

Colorant: carbon black, phthalocyanine, quinacridon, indoline, azo pigments, red oxide, and the like.

Filler: glass fiber, vallastonite, calcium silicate, and the like.

Before making the heat-sealable barrier polymer composition (A), components in the heat-sealable barrier polymer composition (A) may be pre-mixed. A method of pre-mixing is not particularly limited but it may be dry-mixed (mixing below melt temperature) and melt-mixed (mixing above melt temperature). The components may be pulverized in advance for better mixing efficiency.

### Methods of Preparing Modified EVOH Resin (a)

A method of preparing the modified EVOH resin (a) is not particularly limited, and may include well-known preparing methods. For example, it may include a method, comprising: obtaining a modified ethylene-vinyl ester copolymer represented by the formula (I) by radical polymerization of ethylene, vinyl ester represented by a following formula (II), and an

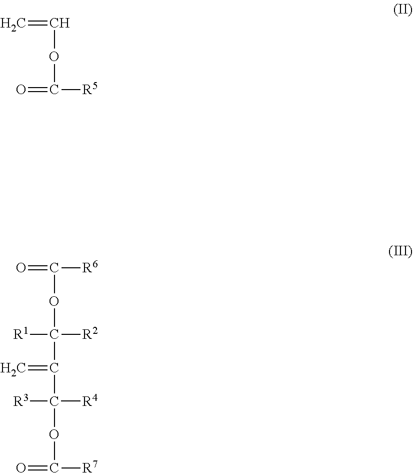

unsaturated monomer represented by a following formula (III); and then saponifying it.

In the formula (II), R⁵ denotes a hydrogen atom or an alkyl group having a carbon number of from 1 to 9. A carbon number of the alkyl group is preferably from 1 to 4. Vinyl ester represented by the formula (II) is exemplified by vinyl formate, vinyl acetate, vinyl propionate, vinyl butyrate, vinyl isobutyrate, vinyl pivalate, vinyl versatate, vinyl caproate, and the like. In an economic perspective, vinyl acetate is particularly preferred.

In the formula (III), R¹, R², R³, and R⁴ are same as those in the formula (I). Each of R⁶ and R⁷ independently denotes a hydrogen atom or an alkyl group having a carbon number of from 1 to 9. A carbon number of the alkyl group is preferably from 1 to 4. The unsaturated monomer represented by the formula (III) may include 2-methylene-1,3-propanediol diacetate, 2-methylene-1,3-propanediol dipropionate, 2-methylene-1,3-propanediol dibutyrate, and the like. Among all, 2-methylene-1,3-propanediol diacetate is preferably used in view of easy production. In a case of 2-methylene-1,3-propanediol diacetate, R¹, R², R³, and R⁴ are hydrogen atoms, and R⁶ and R⁷ are methyl groups.

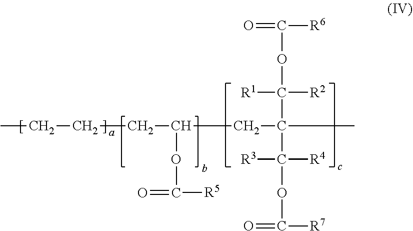

In the formula (IV), R¹, R², R³, R⁴, R⁵, R⁶, R⁷, a, b, and c are same as the formulae (I) through (III). The modified ethylene-vinyl ester copolymer thus obtained is a new polymer and is subjected to saponification treatment after that.

In addition, instead of the unsaturated monomer represented by the above formula (III), an unsaturated monomer represented by the following formula (V) may also be copolymerized, and in this case, only the units derived from the unsaturated monomer represented by the above formula (II) are saponified.

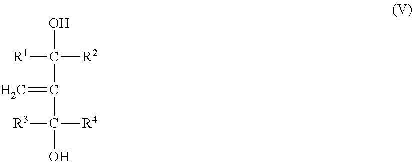

In the formula (V), R¹, R², R³, and R⁴ are same as those in the formula (I). The unsaturated monomer represented by the formula (V) may include 2-methylene-1,3-propanediol.

The unsaturated monomers represented by the formula (III) and the formula (V) used in the present invention have high copolymerization reactivity with vinyl ester monomers, so that copolymerization reaction proceeds easily. Accordingly, it is easy to increase an amount of modification and a degree of polymerization of the modified ethylene-vinyl ester copolymer thus obtained. In addition, an amount of the unreacted unsaturated monomers remaining after polymerization is less even when the polymerization reaction is stopped at a low conversion, so that it is excellent in respect of environment and cost. The unsaturated monomers represented by the formula (III) and the formula (V) are preferred over other monomers such as allyl glycidyl ether and 3,4-diacetoxy-1-butene, having a functional group in an allylic position and having only one carbon atom. Here, the unsaturated monomer represented by the formula (III) has higher reactivity than the unsaturated monomer represented by the formula (V).

The mode of polymerization for production of a modified ethylene-vinyl ester copolymer by copolymerizing ethylene, vinyl ester represented by the above formula (II), and the unsaturated monomer represented by the above formula (III) or (V) may be any of batch polymerization, semi-batch polymerization, continuous polymerization, and semi-continuous polymerization. In addition, as the method of polymerization, it is possible to employ a known method, such as a bulk polymerization method, a solution polymerization method, a suspension polymerization method, and an emulsion polymerization method. A bulk polymerization method or a solution polymerization method is usually employed, in which polymerization proceeds without solvent or in a solvent, such as an alcohol. In a case of obtaining a modified ethylene-vinyl ester copolymer with a high degree of polymerization, employment of an emulsion polymerization method becomes an option.

Although a solvent used in a solution polymerization method is not particularly limited, alcohol is used preferably, and lower alcohol, such as methanol, ethanol, and propanol, for example, are more preferably used. An amount of solvent use in a polymerization reaction liquid may be selected considering the intended viscosity average degree of polymerization of the modified EVOH and chain transfer of the solvent, and a weight ratio of the solvent to the total monomers contained in the reaction liquid (solvent/total monomers) is selected from a range of from about 0.01, or from about 0.05, to about 10, or to about 3.

A polymerization initiator used for copolymerization of ethylene, vinyl ester represented by the above formula (II), and the unsaturated monomer represented by the above formula (III) or (V) is selected in accordance with the method of polymerization from known polymerization initiators, for example, an azo initiator, a peroxide initiator, and a redox initiator. The azo initiator may include, for example, 2,2′-azobisisobutyronitrile, 2,2′-azobis (2,4-dimethylvaleronitrile), and 2,2′-azobis (4-methoxy-2,4-dimethylvaleronitrile). The peroxide initiator may include, for example, percarbonate compounds, such as diisopropyl peroxydicarbonate, di-2-ethylhexyl peroxydicarbonate, and diethoxyethyl peroxydicarbonate; perester compounds, such as t-butylperoxy neodecanoate, α-cumylperoxy neodecanoate, and acetyl peroxide; acetylcyclohexylsulfonyl peroxide; 2,4,4-trimethylpentyl-2-peroxyphenoxyacetate; and the like. Potassium persulfate, ammonium persulfate, hydrogen peroxide, and the like may also be used in combination with the above initiators. The redox initiator is a polymerization initiator in which, for example, the above peroxide initiators and a reducing agent, such as sodium hydrogen sulfite, sodium hydrogen carbonate, tartaric acid, L-ascorbic acid, and rongalite, are combined. An amount of polymerization initiator use is different depending on the polymerization catalyst and thus is not determined unconditionally, and it is adjusted in accordance with the conversion. The amount of polymerization initiator use based on vinyl ester monomers is preferably from about 0.01 mol %, or from about 0.02 mol %, to about 0.2 mol %, or to about 0.15 mol %. Although the polymerization temperature is not particularly limited, it is appropriately from room temperature, or not less than about 40° C. to about 150° C., but not more than a boiling point of a solvent to be used.

For copolymerization of ethylene, vinyl ester represented by the above formula (II), and the unsaturated monomer represented by the above formula (III) or (V), they may be copolymerized in the presence of a chain transfer agent as long as not inhibiting the effects of the present invention. The chain transfer agent may include, for example, aldehydes, such as acetaldehyde and propionaldehyde; ketones, such as acetone and methylethylketone; mercaptans, such as 2-hydroxyethanethiol; and phosphinates, such as sodium phosphinate monohydrate. Among all, aldehydes and ketones are used preferably. Although an amount of adding the chain transfer agent to the polymerization reaction liquid is determined in accordance with the chain transfer constant of the chain transfer agent and the intended degree of polymerization of the modified ethylene-vinyl ester copolymer, it is preferably from about 0.1 to about 10 parts by mass based on 100 parts by mass of the vinyl ester monomer in general.

It is possible to obtain the modified EVOH of the present invention by saponifying the modified ethylene-vinyl ester copolymer thus obtained. At this time, the vinyl ester units in the copolymer are converted to vinyl alcohol units. In addition, ester bonds derived from the unsaturated monomer represented by the formula (III) are also hydrolyzed at the same time to be converted to a 1,3-diol structure. In such a manner, it is possible to hydrolyze different kinds of ester group by one saponification reaction at the same time.

It is possible to employ a known method for a method of saponifying the modified ethylene-vinyl ester copolymer. The saponification reaction is usually carried out in an alcohol or hydrous alcohol solution. Alcohol preferably used at this time is lower alcohol, such as methanol and ethanol, and particularly preferably methanol. Alcohol or hydrous alcohol used for the saponification reaction may contain another solvent, as long as the solvent is not more than about 40 wt % of its weight, such as acetone, methyl acetate, ethyl acetate, and benzene. The catalyst used for the saponification is, for example, alkali metal hydroxides, such as potassium hydroxide and sodium hydroxide; alkali catalysts, such as sodium methylate; and acid catalysts, such as mineral acid. Although the temperature to carry out the saponification is not limited, it is preferably in a range of from about 20° C. to about 120° C. In a case that gelatinous products precipitate as the saponification proceeds, it is possible to obtain modified EVOH by grinding the products and then washing and drying them.

A modified ethylene-vinyl alcohol polymer of the present invention may contain a structural unit derived from another ethylenic unsaturated monomer that is copolymerizable with ethylene, vinyl ester represented by the above formula (II), and the unsaturated monomer represented by the above formula (III) or (V) as long as not inhibiting the effects of the present invention. Such ethylenic unsaturated monomer may include, for example, α-olefins, such as propylene, n-butene, isobutylene, and 1-hexene; acrylic acid and salts thereof, unsaturated monomers containing an acrylic ester group; methacrylic acid and salts thereof, unsaturated monomers containing a methacrylic ester group; acrylamide, N-methylacrylamide, N-ethylacrylamide, N,N-dimethylacrylamide, diacetoneacrylamide, acrylamide propane sulfonic acid and salts thereof, and acrylamidopropyl dimethylamine and salts thereof (for example, quaternary salts); methacrylamide, N-methylmethacrylamide, N-ethylmethacrylamide, methacrylamide propane sulfonic acid and salts thereof, and methacrylamidopropyl dimethylamine and salts thereof (for example, quaternary salts); vinyl ethers, such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; vinyl cyanides, such as acrylonitrile and methacrylonitrile; vinyl halides, such as vinyl chloride and vinyl fluoride; vinylidene halides, such as vinylidene chloride and vinylidene fluoride; allyl compounds, such as allyl acetate, 2,3-diacetoxy-1-allyloxypropane, and allyl chloride; unsaturated dicarboxylic acids, such as maleic acid, itaconic acid, and fumaric acid, and salts thereof or esters thereof; vinylsilane compounds, such as vinyltrimethoxysilane

### Multilayer Articles

In the multilayer articles of the present invention, one or more layers other than the layer of the heat-sealable barrier polymer composition (A) (barrier sealant layer) may optionally be included depending on requirements of the end use. Such other layers may comprise thermoplastic resins, plasticizers, lubricants, stabilizers, surfactants, colorants, ultraviolet absorbers, antistatic agents, desiccants, crosslinkers, metal salts, fillers, reinforcing agents such as various fibers, and the like blended therein.

The thermoplastic resin used for the other layer may include polyethylenes, such as linear low density polyethylene, low density polyethylene, very low density polyethylene, medium density polyethylene, and high density polyethylene; homo- or co-polymers of olefin, such as ethylene-vinyl acetate copolymers, ionomers, ethylene-propylene (block or random) copolymers, ethylene-(meth) acrylic acid copolymers, ethylene-(meth)acrylic ester copolymers, polypropylene, propylene-α-olefin copolymers, polybutene, and polypentene, or polyolefins, such as those graft modified with unsaturated carboxylic acid or esters thereof; polyester; polyamide (including copolyamide); polyvinyl chloride; polyvinylidene chloride; acrylic resins; polystyrene; polyvinyl ester; polyester elastomers; polyurethane elastomers; chlorinated polystyrene; chlorinated polypropylene; aromatic polyketone or aliphatic polyketone, and polyalcohol obtained by reducing them; polyacetal; polycarbonate; and the like.

Also, it is possible to use paper, aluminum metal, and metal oxides such as silica or alumina for other layers. These layers may also include a combination of these materials.

An adhesive layer for adhering the layer of the heat-sealable barrier polymer composition (A) to other layers may be included in the other layers. Preferred resins for use as the adhesive resin include polyolefins modified with unsaturated carboxylic acid or a derivative thereof. Typical examples of suitable adhesive resins include carboxyl group-containing modified polyolefin resins obtained by chemically binding an unsaturated carboxylic acid or an anhydride thereof to a polyolefin resin. Specific examples of the adhesive resin include polyethylenes modified with maleic anhydride, polypropylenes modified with maleic anhydride, a maleic anhydride-modified ethylene-ethyl acrylate copolymer, and a maleic anhydride-graft-modified ethylene-vinyl acetate copolymer. In terms of mechanical strength and molding processability, polyethylenes modified with maleic anhydride and polypropylenes modified with maleic anhydride are preferable, and polyethylenes modified with maleic anhydride are particularly preferable among these. Also, adhesive layer may also include other materials, like polyurethane.

The layer structure of the multilayer article of the present invention is not particularly limited, except that the layer of the heat-sealable barrier polymer composition (A) is always the innermost layer.

When the multilayer structure described below is used for a multilayer article, the leftmost layer is the innermost layer, and the rightmost layer is the outermost layer.

Three layers: A/O/O

Four layers: A/G/G/O

Five layers: A/O/O/O/O

In the above, “A” represents the barrier layer in accordance with the present invention, and “O” represents the other layers.

Although a thickness of the entire multilayer article is not particularly limited, it is usually from about 10 μm to about 2,000 μm thick depending on requirement as multilayer article.

A thickness of the layer of the heat-sealable barrier polymer composition (A) is also not particularly limited, and is usually from about 5 μm to about 1,000 μm thick depending on requirement as multilayer article. The thickness of the layer of the heat-sealable barrier polymer composition (A) is preferably from about 10 μm, or from about 20 μm, to about 500 μm, or to about 100 μm. If the thickness of the layer of the heat-sealable barrier polymer composition (A) is set within the above range, it is possible to achieve the barrier properties, anti-scalping properties and heat seal properties at a high level. If the thickness is less than the above lower limit, it is impossible to carry out heat seal having sufficient seal strength. On the other hand, when the thickness exceeds the upper limit, it is difficult to be heat sealed because the heat cannot conduct well.

The method for producing the multilayer article of the present invention is not particularly limited. Common methods to produce monolayer article or multilayer article such as extrusion, coextrusion, dry lamination, extrusion coating, coextrusion coating can be applied. Preferably, a method of coextruding the heat-sealable barrier polymer composition (A) and other materials, a method of extrusion-coating the heat-sealable barrier polymer composition (A) on other materials, a method of dry laminating monolayer article of the heat-sealable barrier polymer composition (A) with articles from other materials are used. The multilayer article can be oriented by uniaxial stretching or biaxial stretching. Metal or metal oxide can be coated on the multilayer article by a known vapor deposition method.

### Flexible Packaging

The multilayer article can be formed into a flexible packaging by heat seal with the layer of the heat-sealable barrier polymer composition (A) inside. The flexible packaging may be a flat pouch, a stand up pouch or the like.

A method of heat sealing is not particularly limited, and a known method can be used. For example, a method of heat sealing with a hot plate heat sealer, an impulse sealer, an ultrasonic sealer, a friction heat sealer, a dielectric heating sealer or the like can be used. The temperature at the time of heat sealing is not particularly limited, from the viewpoint of heat seal strength and the appearance, it is preferably from the melting point of the heat-sealable barrier polymer composition (A) to the temperature which is the melting point +30° C. The pressure for heat sealing is not particularly limited, it is preferably from about 0.01 MPa to about 2.0 MPa in terms of heat seal strength. The time for heat sealing is not particularly limited, but it is preferably from about 0.05 seconds to about 5 seconds in terms of heat seal strength and appearance.

### EXAMPLES

The present invention is more specifically described by way of examples. The scope of the present invention, however, is not limited to these examples. It is to be noted that production methods as well as methods of measurement, calculation and evaluation in Examples and Comparative Examples are each as described below.

### Materials

Modified EVOH 1: Ethylene content 38 mol %, degree of modification 2.5 mol %, degree of saponification >99.9 mol %, melting point 152° C., MFR 3.9 g/10 min (190° C., 2160 g).

Modified EVOH 2: Ethylene content 38 mol %, degree of modification 1.5 mol %, degree of saponification >99.9 mol %, melting point 160° C., MFR 6.5 g/10 min (190° C., 2160 g).

Modified EVOH 3: ethylene content 38 mol %, degree of modification 1.5 mol %, degree of saponification >99.9 mol %, melting point 160° C., MFR 2.0 g/10 min (190° C., 2160 g).

Modified EVOH 4: Ethylene content 44 mol %, degree of modification 1.0 mol %, degree of saponification >99.9 mol %, melting point 154° C., MFR 2.0 g/10 min (190° C., 2160 g).

Comparative EVOH 1: EVAL™ H171B, Ethylene-Vinyl Alcohol copolymer commercially available from Kuraray Co., Ltd. (ethylene content 38 mol %, degree of saponification >99.9 mol %, melting point 172° C., MFR 1.7 g/10 minutes (190° C., 2160 g)).

Comparative EVOH 2: EVAL™ E105B, Ethylene-Vinyl Alcohol copolymer commercially available from Kuraray Co., Ltd. (ethylene content 44 mol %, degree of saponification >99.9 mol %, melting point 165° C., MFR 5.5 g/10 minutes (190° C., 2160 g)).

Comparative EVOH 3: EVAL™ G176B, Ethylene-Vinyl Alcohol copolymer commercially available from Kuraray Co., Ltd. (ethylene content 48 mol %, degree of saponification >99.9 mol %, melting point 157° C., MFR 6.5 g/10 minutes (190° C., 2160 g)).

### Synthetic Examples

### Modified EVOH 1

### (1) Synthesis of Modified EVAc

To a 250 L pressure reaction vessel provided with a jacket, a stirrer, a nitrogen inlet, an ethylene inlet, and an initiator addition port, 100 kg of vinyl acetate (hereinafter, referred to as VAc), 5.7 kg of methanol (hereinafter, may be referred to as MeOH), and 3.0 kg of 2-methylene-1,3-propanediol diacetate (hereinafter, referred to as MPDAc) were charged, and the temperature was raised to 60° C., and after that, nitrogen bubbling was carried out for 30 minutes to purge inside the reaction vessel with nitrogen. Subsequently, ethylene was introduced to have a reaction vessel pressure (ethylene pressure) of 5.1 MPa. The temperature in the reaction vessel was adjusted to 60° C., then 50.0 g of 2,2′-azobis (2,4-dimethylvaleronitrile) (“V-65” produced by Wako Pure Chemical Industries, Ltd.) as an initiator was added in the form of methanol solution to initiate polymerization. During the polymerization, the ethylene pressure was maintained at 5.1 MPa and the polymerization temperature was maintained at 60° C. And, MPDAc methanol solution with concentration of 30 wt % was continuously added into polymerization solution at 350 mL/15 minutes. After 6.5 hours, when the conversion of VAc became 41%, MPDAc feed was stopped and the vessel was cooled to room temperature. Then, 200 g of sorbic acid was added in the form of methanol solution to stop polymerization completely. After removing ethylene by opening the reaction vessel, a nitrogen gas was bubbled to completely remove ethylene. Subsequently, after unreacted VAc was removed under reduced pressure, MeOH was added to the modified ethylene-vinyl acetate copolymer (herein, may be referred to as modified EVAc) to which a structural unit derived from MPDAc was introduced by copolymerization to have a 20 mass % MeOH solution.

### (2) Saponification of Modified EVAc

To a 500 L reaction vessel provided with a jacket, a stirrer, a nitrogen inlet, a reflux condenser, and a solution addition port, the 20 mass % MeOH solution of the modified EVAc obtained in (1) was charged. The temperature was raised to 60° C., while blowing nitrogen into the solution, and 0.5 equivalent of sodium hydroxide (based on vinyl acetate unit in the modified EVAc) was added as a MeOH solution having a sodium hydroxide concentration of 2 N. After completion of adding the MeOH sodium hydroxide solution, saponification reaction proceeded by stirring for two hours while keeping the temperature in the system at 60° C. After that, acetic acid was added to stop the saponification reaction. After that, while heating and stirring at 60-80° C., an ion exchange water was added to drain MeOH outside the reaction vessel and to precipitate modified EVOH. The precipitated modified EVOH was collected by decantation and ground with a mixer. The modified EVOH powder thus obtained was added in a 1 g/L aqueous acetic acid solution (bath ratio of 20:proportion of 1 kg of the powder to 20 L of the aqueous solution) and it was stirred and washed for two hours. It was drained and was further washed in a 1 g/L aqueous acetic acid solution (bath ratio of 20) and with stirring for two hours. It was again drained and washed in ion exchange water (bath ratio of 20) with stirring for two hours, which was repeated three times to carry out refinement. Subsequently, it was stirred and immersed in 10 L of an aqueous solution containing 0.5 g/L of acetic acid and 0.1 g/L of sodium acetate for four hours and then deliquored, and then dried at 60° C. for 16 hours to obtain roughly dried modified EVOH 1.

### (3) Production of Modified EVOH Hydrous Pellet

To an 80 L stirring vessel provided with a jacket, a stirrer, and a reflux condenser, the roughly dried modified EVOH 1, water, and MeOH were charged and the temperature was raised to 80° C. for dissolution. The solution was extruded in a liquid mixture of water/MeOH:90/10, cooled to 5° C. through a glass tube having a diameter of 4 mm to be precipitated in the form of strand, and the strand was cut with a strand cutter into pellets to obtain modified EVOH 1 hydrous pellets. The moisture content of the modified EVOH 1 hydrous pellets thus obtained was measured by a halogen moisture meter “HR 73” manufactured by Mettler, and it was 60 mass % as wet basis.

### (4) Production of Modified EVOH Composition Pellet

In a 1 g/L aqueous acetic acid solution (bath ratio of 20), the modified EVOH 1 hydrous pellets obtained in (3) above were added and stirred and washed for two hours. It was drained and was further added to a 1 g/L aqueous acetic acid solution (bath ratio of 20), and it was stirred and washed for two hours. After deliquoring, the aqueous acetic acid solution was renewed and same operation was carried out. After washing with the aqueous acetic acid solution and then draining it, it was washed in ion exchange water (bath ratio of 20) with stirring for two hours, then deliquored and repeated three times to carry out purification. Modified EVOH 1 hydrous pellets were thus obtained from which the catalyst residue during the saponification reaction was removed. The hydrous pellets were added to an aqueous solution (bath ratio of 20) having a concentration of sodium acetate of 0.5 g/L, an acetic acid concentration of 0.8 g/L, a phosphoric acid concentration of 0.005 g/L, and a boric acid concentration of 0.14 g/L immersed for four hours while periodically stirred. They were drained and dried at 80° C. for three hours and at 105° C. for 16 hours, thereby obtaining modified EVOH 1 composition pellets containing acetic acid, sodium salt, a phosphate compound and a boric acid.

### Modified EVOH 2

Modified EVOH 2 was synthesized with the ethylene content, MPDAc content and degree of saponification shown in Table 1. The synthesis procedure was the same as that of Modified EVOH 1, except that 12 kg of MeOH and 1.8 kg of MPDAc were charged. And, ethylene was introduced to have a reaction vessel pressure (ethylene pressure) of 5.0 MPa. 120.0 g of 2,2′-azobis (2,4-dimethylvaleronitrile) (“V-65” produced by Wako Pure Chemical Industries, Ltd.) as an initiator was added. MPDAc methanol solution with concentration of 16 wt % was continuously added into polymerization solution at 550 mL/15 minutes. MPDAc feed was stopped and the vessel was cooled to room temperature, after 5.0 hours when the conversion of VAc became 45%. Then, 480 g of sorbic acid was added in the form of methanol solution to stop polymerization completely. When modified EVOH composition pellet was produced, boric acid was not added to an aqueous solution to treat the hydrous pellet.

### Modified EVOH 3

Modified EVOH 3 can be synthesized with the ethylene content, MPDAc content and degree of saponification shown in Table 1. The synthesis procedure can be the same as that of Modified EVOH 1, except that 8.0 kg of MeOH and 1.8 kg of MPDAc can be charged. And, ethylene can be introduced to have a reaction vessel pressure (ethylene pressure) of 5.1 MPa. 120.0 g of 2,2′-azobis (2,4-dimethylvaleronitrile) (“V-65” produced by Wako Pure Chemical Industries, Ltd.) as an initiator can be added. MPDAc methanol solution with concentration of 16 wt % can be continuously added into polymerization solution at 560 mL/15 minutes. MPDAc feed can be stopped and the vessel can be cooled to room temperature, after 5.0 hours when the conversion of VAc becomes 45%. Then, 480 g of sorbic acid can be added in the form of methanol solution to stop polymerization completely. When modified EVOH composition pellet is produced, a boric acid concentration of 0.34 g/L can be used for an aqueous solution to treat the hydrous pellet.

### Modified EVOH 4

Modified EVOH 4 was synthesized with the ethylene content, MPDAc content and degree of saponification shown in Table 1. The synthesis procedure was the same as that of Modified EVOH 1, except that 90 kg of VAc, 9.0 kg of MeOH and 0.9 kg of MPDAc were charged. And, ethylene was introduced to have a reaction vessel pressure (ethylene pressure) of 6.1 MPa. 108.0 g of 2,2′-azobis (2,4-dimethylvaleronitrile) (“V-65” produced by Wako Pure Chemical Industries, Ltd.) as an initiator was added. MPDAc methanol solution with concentration of 16 wt % was continuously added into polymerization solution at 340 mL/15 minutes. MPDAc feed was stopped and the vessel was cooled to room temperature, after 5.5 hours when the conversion of VAc became 45%. Then, 432 g of sorbic acid was added in the form of methanol solution to stop polymerization completely. When modified EVOH composition pellet was produced, a boric acid concentration of 0.44 g/L was used for an aqueous solution to treat the hydrous pellet.

### Analysis for Modified EVOH

### Content of Each Structural Unit in Modified EVAc 1-4

In the modified EVAc 1-4, the contents of ethylene units (a) (mol %), the contents of structural units derived from VAc (b) (mol %) and the content of structural units derived from MPDAc (c) (mol %) were calculated based on the spectrum obtained by ¹H-NMR (nuclear magnetic resonance) measurement of the modified EVAc before saponification following the method described in U.S. Pat. No. 9,663,592B. 500 MHz ¹H-NMR (“GX-500” manufactured by JEOL Ltd.) was used for measurement. Contents of ethylene units (a) (mol %) and the contents of structural units derived from MPDAc (mol %) in the modified EVAc 1-4 was same as ethylene contents (mol %) and content of the modified group (mol %) in the modified EVOH 1-4, respectively. The results are shown in Table 1.

### Degree of Saponification in Modified EVAc 1-4

The degree of saponification of the modified EVOH were calculated based on the spectrum obtained by ¹H-NMR (nuclear magnetic resonance) measurement following the method described in U.S. Pat. No. 9,663,592B. 500 MHz ¹H-NMR (“GX-500” manufactured by JEOL Ltd.) was used for measurement. The results are shown in Table 1.

### Ethylene Content and Degree of Saponification in Unmodified EVOH

The ethylene content (mol %) and the degree of saponification (mol %) of the EVOH for comparative EVOH 1-3 were calculated based on the spectrum obtained by ¹H-NMR (nuclear magnetic resonance) measured using a dimethyl sulfoxide (DMSO)-d₆ as a solvent. 500 MHz ¹H-NMR (“GX-500” manufactured by JEOL Ltd.) was used for measurement. The results are shown in Table 1.

### Melt Flow Rate (MFR)

The melt flow rate (g/10 minutes) of the modified EVOH composition pellets was measured by a melt flow indexer (MP1200, Tinius Olsen TMC, Horsham, Pa. USA) under conditions of a temperature at 190° C. and with a load of 2160 g. The results are shown in Table 1.

### Melting Point

Measurement of the modified EVOH composition pellets was performed according to JIS K7121 by raising the temperature from 30° C. to 215° C. at a rate of 10° C./min., and after that, rapidly cooling it to −35° C. at 100° C./min., and again raising the temperature from −35° C. to 195° C. at a rate of temperature rise of 10° C./min. (differential scanning calorimeter (DSC) “RDC220/SSC5200H” manufactured by Seiko Instruments & Electronics Ltd). The results are shown in Table 2.

### Examples 1-4

### Preparation of Monolayer Film

Using the modified EVOH composition pellets, monolayer film formation was carried out using a 20 mm extruder “D2020” (D (mm):20, L/D:20, compression ratio:2.0, screw: full flight) manufactured by Toyo Seiki Seisaku-Sho, Ltd. under the conditions below to obtain a monolayer film.

Cylinder Temperature:

Supply area: 175° C.

Compression area: melting point of modified EVOH or EVOH+30 to 45° C.

Measurement area: melting point of modified EVOH or EVOH+30 to 45° C.

Die temperature: melting point of modified EVOH or EVOH+30 to 45° C.

Screw rotation speed: from 40 to 100 rpm

Amount of throughput: from 0.4 to 1.5 kg/hour

Drawing roll temperature: 80° C.

Drawing roll speed: from 0.8 to 3.2 m/min.

Film thickness: from 20 to 150 um

### Measurement of Oxygen Transmission Rate

The monolayer film having a thickness of 20 μm was moisture conditioned at 20° C. and 65% RH for three days, and after that, measurement (“OX-TORAN MODEL 2/21” manufactured by MOCON, Inc.) of the oxygen transmission rate was carried out in the same conditions. The results are shown in Table 2.

### Measurement of Anti-Scalping Property

Nicotine and methyl salicylate were used to evaluate anti-scalping property. 40 mg of each substance was placed in a glass bottle (50 cm3 volume). The monolayer film having a thickness of 30 μm was cut by 1 cm by 4 cm and placed in the glass bottle without direct contact between the substance and the monolayer film. They were left at 20° C./50% RH for two weeks.

Thermal Desorption Cold Trap Injector (“CP-4020” by CROMPACK Corporation) and CG/MS (Type 5973 by Ajilent Technologies) were used for measuring amount of absorbed substance in the monolayer film. A gas sample was collected as follows. The monolayer film was placed in a glass chamber at 80° C. and nitrogen carrier gas was run at 100 mL/minutes to collect the gas sample in Tenax sorbent tube for 3 minutes. The Tenax sorbent tube was heated at 250° C. for desorption. The desorbed gas was trapped at −130° C. and then heated at 250° C. to introduce it to GC/MS. The results are shown in Table 2. As can be seen from the results, there is a correlation between OTR and anti-scalping property, and good results of anti-scalping property are obtained when the OTR value is good.

### Preparation of Multilayer Film

A multilayer film was prepared by dry lamination method. A two-component adhesive (including A-520 (trade name) and A-50 (trade name) manufactured by Mitsui Chemicals, Inc.) was applied and dried on a biaxial oriented polyester (PET) film with 12 microns thickness (FE2001 available from Futamura Chemical Co., Ltd.). The PET film and the monolayer film made of the modified EVOH composition pellets obtained above (modified EVOH 3) with 30 microns thickness were laminated together to obtain a multilayer film. Thickness of the adhesive layer was 4 microns.

### Water Content of Multilayer Film

Water content of the multilayer film was calculated by its weight change. The weight of the multilayer film which was cut 200 mm by 200 mm was measured and defined as “Wc”. The multilayer film was placed in the oven at 120° C. for 2 hours, and then the weight was measured again and defined as “Wd”. The water content of the multilayer film was calculated by the formula below.

Water content (wt %)=(Wc−Wd)/Wd×100

### Evaluation of Heat Seal Property

The multilayer film was stored with moisture-proof bag at room temperature, or left in the air-conditioned oven and exposed at 20° C.90% RH for 1 month.

Three side seal pouches made of the multilayer film were made by a vertical form-fill-seal machine (“KP-109” manufactured by Komack Co., Ltd.). The pouch size is 80 mm in width and 70 mm in length. Seal width is 14 mm in machine direction and 8 mm in traverse direction where heat seal strength is measured. Numbers of pouch made was 100 pouches per minutes. Heat seal strength was measured under 23° C./50% RH by Universal Electromechanical Test Frames (“AGS-H” by SHIMADZU CORPORATION). The width of test strip taken from the pouch was 15 mm and peeled at 250 mm/minutes. The results of samples made at 180° C. or 160° C. are shown in Table 2. We can find that when the melting point is low, the heat seal strength tends to be higher. We also find Example 3 yields good heat seal property even water is absorbed, while Comparative Example 2 is blistered due to moisture pick-up and not heat-sealed.

### Evaluation of Hot Tack Property

A hot tack seal strength was measured by Hot tack tester by Teller Corporation. A test strip made of the multilayer film was 25 mm by 300 mm. The test condition was seal temperature from 100 to 160° C., seal pressure at 2.0 MPa and seal time at 1.0 second. The hot tack property of Example 3 was obtained from a low temperature 100° C., it means that it is possible to process under a wider range of conditions, and it can be more easily coextruded with a material which has a low melting point. The thermal deterioration of product films can be reduced. The test results are shown in FIGURE.

### Comparative Example 1-3

Monolayer film and multilayer film were prepared from Comparative EVOH 1 to 3, then evaluated in a same manner as Example 3.

Compared to the result of Example 3, the heat seal strength of Comparative Example 1 is poor. Both the heat seal strength and the barrier property of Comparative Example 2 are poor, and in particular, the anti-scalping property to methyl salicylate is very poor. And compared with Example 3, the hot tack property of Comparative Example 2 was obtained from a higher temperature, also the heat seal property of Comparative Example 2 is worse than that of Example 3. With respect to Comparative Example 3, although the heat seal strength is not bad, the barrier property is poor. Therefore, Comparative Example 1-3 do not achieve both barrier properties, anti-scalping properties and heat seal properties. The results are shown in Table 2 and FIGURE.

TABLE 1

| | | | | | | | Degree | MFR |
|---|---|---|---|---|---|---|---|---|
| | | Ethylene | | | | | of | 190° C./ |
| | | content | Modification | | Structure in formula (I) | | sapon. | 2160 g |
| | | mol % | Modifier | mol % | X | R1 | mol % | g/10 min. |
| Ex 1 | Modified | 38 | MPDAc | 2.5 | —CH2—OH | Direct | >99.9 | 3.9 |
| | EVOH1 | | | | | bond | | |
| Ex 2 | Modified | 38 | MPDAc | 1.5 | —CH2—OH | Direct | >99.9 | 6.5 |
| | EVOH2 | | | | | bond | | |
| Ex 3 | Modified | 38 | MPDAc | 1.5 | —CH2—OH | Direct | >99.9 | 2.0 |
| | EVOH3 | | | | | bond | | |
| Ex 4 | Modified | 44 | MPDAc | 1.0 | —CH2—OH | Direct | >99.9 | 2.0 |
| | EVOH4 | | | | | bond | | |
| C Ex 1 | EVOH 1 | 38 | — | 0 | — | — | >99.9 | 1.7 |
| C Ex 2 | EVOH 2 | 44 | — | 0 | — | — | >99.9 | 5.5 |
| C Ex 3 | EVOH 3 | 48 | — | 0 | — | — | >99.9 | 6 |

MPDAc: 2-methylene-1,3-propanediol diacetate

TABLE 2

| | | | | | | Multilayer film | | | |
|---|---|---|---|---|---|---|---|---|---|
| | | | Monolayer film | | | Stored by moisture- | | | |
| | | | | Amount of | | proof bag | | Exposed at 20° C. 90% RH | |
| | | Melting | Oxygen | absorption (*3) | | | Seal | | Seal |
| | | point | permeability | | Methyl | Water | strength at | Water | strength at |
| | | (*1) | (*2) | Nicotine | salicylate | content | 180° C. (*4) | content | 160° C. (*4) |
| Ex 1 | Modified | 152 | 0.4 | Not | Not | 0.2 | 22.5 | Not | Not |
| | EVOH1 | | | measured | measured | | | measured | measured |
| Ex 2 | Modified | 160 | 0.5 | Not | Not | 0.2 | 20.2 | Not | Not |
| | EVOH2 | | | measured | measured | | | measured | measured |
| Ex 3 | Modified | 160 | 0.5 | 131 | 2.54 | 0.2 | 20.4 | 2.9 | 18.6 |
| | EVOH3 | | | | | | | | |
| Ex 4 | Modified | 154 | 1.8 | 365 | 189 | 0.2 | 22.8 | Not | Not |
| | EVOH4 | | | | | | | measured | measured |
| C Ex 1 | EVOH 1 | 172 | 0.7 | Not | Not | 0.2 | Not sealed | Not | Not |
| | | | | measured | measured | | | measured | measured |
| C Ex 2 | EVOH 2 | 165 | 1.5 | 313 | 208 | 0.2 | 15.8 | 2.7 | Not sealed |
| | | | | | | | | | Blistered |
| C Ex 3 | EVOH 3 | 157 | 3.2 | 559 | 514 | 0.2 | 18.1 | Not | Not |
| | | | | | | | | measured | measured |

(*1) unit: ° C.
(*2) unit: cc. 20 microns/m2.day.atm condition: 20° C. 65% RH
(*3) unit: ng/cm2
(*4) unit: N/15 mm condition: MD, 180° C., number of pouch made/min. = 100

1. A multilayer article comprising at least one layer of a heat-sealable barrier polymer composition (A) wherein:
(i) the heat-sealable barrier polymer composition (A) comprises a modified ethylene-vinyl alcohol copolymer of formula (I) as a barrier polymer: 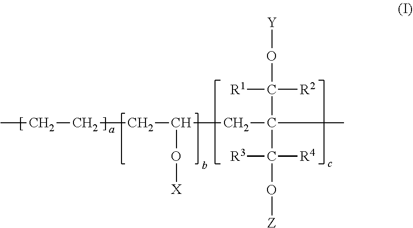
wherein
each of R1, R2, R3, and R4 is independently a hydrogen atom or an alkyl group having a carbon number of from 1 to 10, wherein the alkyl group may optionally include a hydroxyl group, an alkoxy group, or a halogen atom;
each of X, Y, and Z is independently a hydrogen atom, a formyl group, or an alkanoyl group having a carbon number of from 2 to 10.
18≤a≤55;
0.01≤c≤20;
[100−(a+c)]×0.9≤b≤[100−(a+c)]
Degree of Saponification=[(Total Number of Moles of Hydrogen Atoms in X,Y, and Z)/(Total Number of Moles of X,Y, and Z)]×100>90
(ii) the melt temperature of the heat-sealable barrier polymer composition (A) is less than about 160° C. (measured as set forth in the Examples); and
(iii) a layer of a heat-sealable barrier polymer composition (A) is the innermost layer of the multilayer article.

2. The multilayer article according to claim 1, wherein each of R1, R2, R3 and R4 is a hydrogen atom.

3. The multilayer article according to claim 1, wherein each of X, Y, and Z is independently a hydrogen atom or an acetyl group.

4. The multilayer article according to claim 2, wherein each of X, Y, and Z is independently a hydrogen atom or an acetyl group.

5. The multilayer article according to claim 1, wherein a monolayer film prepared from the heat-sealable barrier polymer composition (A) exhibits an oxygen permeability that is less than about 3.2 cc·20 micron/m2·day·atm.

6. The multilayer article according to claim 1, wherein 0.05≤c≤20.

7. A flexible packaging made from a multilayer article comprising at least one layer of a heat-sealable barrier polymer composition (A) wherein:
(i) the heat-sealable barrier polymer composition (A) comprises a modified ethylene-vinyl alcohol copolymer the formula (I) as a barrier polymer: 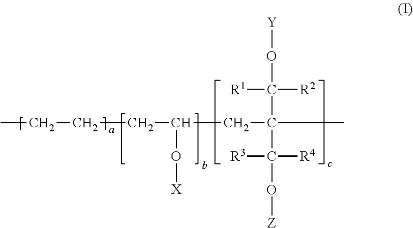
wherein
each of R1, R2, R3, and R4 is independently a hydrogen atom or an alkyl group having a carbon number of from 1 to 10, wherein the alkyl group may optionally include a hydroxyl group, an alkoxy group, or a halogen atom;
each of X, Y, and Z is independently a hydrogen atom, a formyl group, or an alkanoyl group having a carbon number of from 2 to 10.
18≤a≤55;
0.01≤c≤20;
[100−(a+c)]×0.9≤b≤[100−(a+c)]
Degree of Saponification=[(Total Number of Moles of Hydrogen Atoms in X,Y, and Z)/(Total Number of Moles of X,Y, and Z)]×100>90
(ii) the melt temperature of the heat-sealable barrier polymer composition (A) is less than about 160° C. (measured as set forth in the Examples); and
(iii) a layer of a heat-sealable barrier polymer composition (A) is the innermost layer of the multilayer article.

8. The flexible packaging according to claim 7, wherein each of R1, R2, R3 and R4 is a hydrogen atom.

9. The flexible packaging according to claim 7, wherein each of X, Y, and Z is independently a hydrogen atom or an acetyl group.

10. The flexible packaging according to claim 8, wherein each of X, Y, and Z is independently a hydrogen atom or an acetyl group.

11. The flexible packaging according to claim 7, wherein a monolayer film prepared from the heat-sealable barrier polymer composition (A) exhibits an oxygen permeability that is less than about 3.2 cc·20 micron/m2·day·atm.

12. The flexible packaging according to claim 7, wherein 0.05≤c≤20.

13. A packaged product, wherein the product is enclosed in a packaging made from a multilayer article comprising at least one layer of a heat-sealable barrier polymer composition (A) wherein:
(i) the heat-sealable barrier polymer composition (A) comprises a modified ethylene-vinyl alcohol copolymer the formula (I) as a barrier polymer: 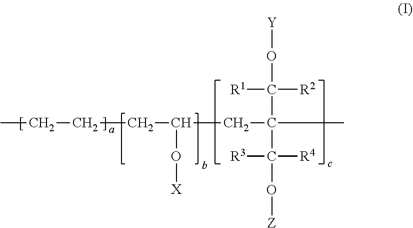
wherein
each of R1, R2, R3, and R4 is independently a hydrogen atom or an alkyl group having a carbon number of from 1 to 10, wherein the alkyl group may optionally include a hydroxyl group, an alkoxy group, or a halogen atom;
each of X, Y, and Z is independently a hydrogen atom, a formyl group, or an alkanoyl group having a carbon number of from 2 to 10.
18≤a≤55;
0.01≤c≤20;
[100−(a+c)]×0.9≤b≤[100−(a+c)]
Degree of Saponification=[(Total Number of Moles of Hydrogen Atoms in X,Y, and Z)/(Total Number of Moles of X,Y, and Z)]×100>90
(ii) the melt temperature of the heat-sealable barrier polymer composition (A) is less than about 160° C. (measured as set forth in the Examples); and
(iii) a layer of a heat-sealable barrier polymer composition (A) is the innermost layer of the multilayer article.

14. The packaged product of claim 13, wherein the packaging is a flexible packaging.
